(19) United States
(12) Patent Application Publication
(10) Pub. No.: US 2013/0330253 A1
(43) Pub. Date: Dec. 12, 2013

(54) WIRELESS POWERED RACK

(71) Applicants: Steven DeCabooter, Middleton, WI (US); Chuck Johnson, Verona, WI (US); Dan Gilson, Madison, WI (US)

(72) Inventors: Steven DeCabooter, Middleton, WI (US); Chuck Johnson, Verona, WI (US); Dan Gilson, Madison, WI (US)

(21) Appl. No.: 13/489,884

(22) Filed: Jun. 6, 2012

(51) Int. Cl. B01L 9/00

(52) U.S. Cl. 422/561

(57) ABSTRACT

A rack used in a device for preparing or analyzing a sample is provided. The rack includes, but is not limited to, a base, a plurality of walls extending from the base, a plate extending between the plurality of walls opposite the base, and a wireless power conductor. The plate includes, but is not limited to, a plurality of cavities. Each cavity of the plurality of cavities is configured to hold a receptacle that is configured to hold a liquid for analysis of a sample or each cavity of the plurality of cavities is configured to hold the liquid for analysis of the sample. The wireless power conductor is mounted to the base and is configured to receive energy by electromagnetic induction from a second wireless power conductor.

### BACKGROUND

In pharmaceutical, genomic and proteomic research and drug development laboratories, as well as similar applications, automated liquid handlers are used for handling laboratory samples in a variety of laboratory procedures to prepare the samples for analysis. For example, liquid handlers are used for biotechnological and pharmaceutical liquid assay procedures, sample preparation, compound distribution, microarray manufacturing, etc. For illustration, automated liquid handlers are disclosed in U.S. Pat. Nos. 4,422,151; 5,988,236; 7,055,402; 7,288,228; 7,669,489; 7,874,324 assigned to the assignee of the present application and incorporated herein by reference. In general, a liquid handler has a work bed that supports one or more sample holding receptacles, with one or more probes mounted to move over the work bed and to aspirate/dispense liquid from/into the sample receptacles.

Liquid chromatography is one example of an application in which automated liquid handlers are used. Liquid chromatography is useful in characterizing a sample through separation of its components by flow through a chromatographic column, followed by detection of the separated components with a flow-through detector. Some liquid chromatography systems include an automated liquid handler to load samples using the one or more probes. A metal needle may be attached to the one or more probes to facilitate extraction of the sample from the container and injection of the sample into an injection port. The one or more probes are generally mounted to an arm that is mounted to a support structure that may be movable in X, Y, and/or Z directions as understood by a person of skill in the art using one or more actuators and controllers. As understood by a person of skill in the art, disposal tips may be used on the one or more probes.

Automated liquid handlers are also used to perform a solid-phase extraction process that separates compounds in a mixture to concentrate and purify samples from the mixture for analysis. In solid-phase extraction, a conditioning liquid flows through a stationary phase to separate desired components from undesired components. One or more washing steps may then be used to eliminate the undesired components. Finally, the desired components may be transferred into a collection receptacle such as a tube or well for further analysis.

### SUMMARY

In an illustrative embodiment, a rack used in a device for preparing or analyzing a sample is provided. The rack includes, but is not limited to, a base, a plurality of walls extending from the base, a plate extending between the plurality of walls, and a wireless power conductor. The plate includes, but is not limited to, a plurality of cavities. Each cavity of the plurality of cavities is configured to hold a receptacle that is configured to hold a liquid for analysis of a sample. The wireless power conductor is mounted to the base and is configured to receive energy by electromagnetic induction from a second wireless power conductor.

In another illustrative embodiment, a liquid handling system is provided. The liquid handling system includes, but is not limited to, a work bed comprising a bed plate, a first wireless power conductor, a drive system, an arm mounted to the drive system, a probe mounted to the arm, a rack configured for mounting on the bed plate, and an actuator. The first wireless power conductor is mounted to the work bed and is configured to transmit energy through electromagnetic induction. The rack includes, but is not limited to, a base, a plurality of walls extending from the base, a rack plate extending between the plurality of walls, and a second wireless power conductor. The rack plate includes, but is not limited to, a plurality of cavities. Each cavity of the plurality of cavities is configured to hold a receptacle that is configured to hold a liquid for analysis of a sample or each cavity of the plurality of cavities is configured to hold the liquid for analysis of the sample. The second wireless power conductor is mounted to the base and is configured to receive energy by electromagnetic induction from the first wireless power conductor when the second wireless power conductor is positioned proximate, but not in contact with the first wireless power conductor. The actuator is operably coupled to control movement of the drive system to position the probe over the receptacle.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a perspective view of a liquid handling system in accordance with an illustrative embodiment.

FIG. 2 depicts a block diagram of a rack used in a device for preparing or analyzing a sample such as the liquid handling system of FIG. 1 in accordance with an illustrative embodiment.

FIG. 3 depicts a block diagram of a device that interfaces with the rack of FIG. 2 in accordance with an illustrative embodiment.

FIG. 4 depicts a top view of a work bed of a device for preparing or analyzing a sample such as the liquid handling system of FIG. 1 in accordance with an illustrative embodiment.

FIG. 5a depicts a perspective view of a liquid handling system in accordance with a second illustrative embodiment.

FIG. 5b depicts a perspective view of a liquid handling system in accordance with a third illustrative embodiment.

FIG. 6 depicts a schematic diagram of a rack, a work bed, and a probe in accordance with an illustrative embodiment.

FIG. 7 depicts a perspective view of the rack of FIG. 2 in accordance with a first illustrative embodiment.

FIG. 8 depicts a perspective view of the rack of FIG. 2 in accordance with a second illustrative embodiment.

FIG. 9 depicts a perspective view of the rack of FIG. 2 in accordance with a third illustrative embodiment.

FIG. 10 depicts a perspective view of the rack of FIG. 2 in accordance with a fourth illustrative embodiment.

FIG. 11 depicts a perspective view of the rack of FIG. 2 in accordance with a fifth illustrative embodiment.

FIG. 12 depicts a perspective view of the rack of FIG. 2 in accordance with a sixth illustrative embodiment.

FIG. 13 depicts a perspective view of the rack of FIG. 2 in accordance with a seventh illustrative embodiment.

### DETAILED DESCRIPTION

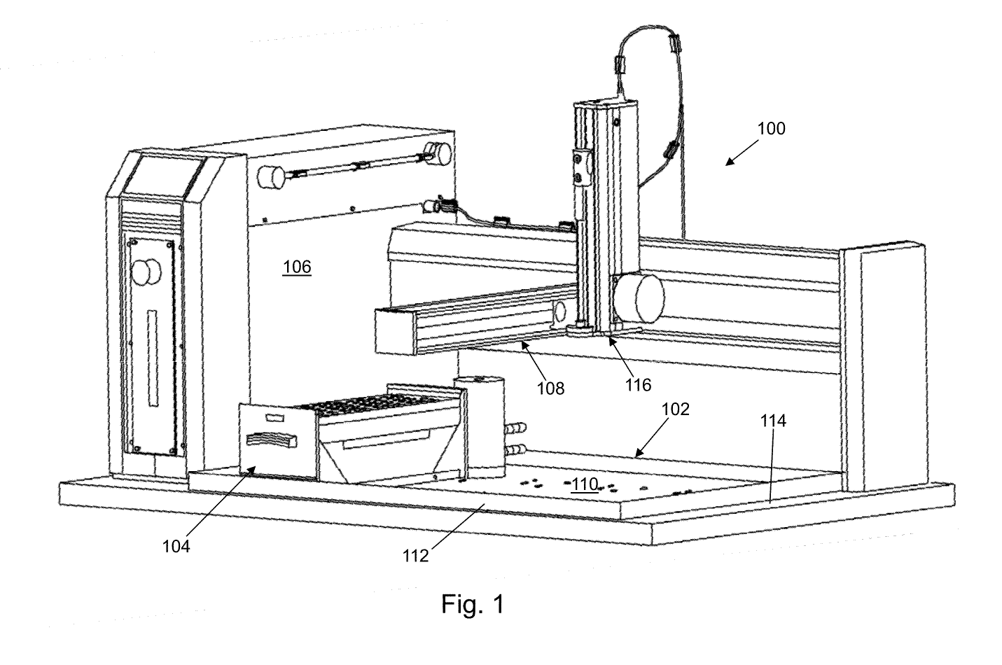

With reference to FIG. 1, a schematic diagram of a liquid handling system 100 is shown in accordance with an illustrative embodiment. Liquid handling system 100 includes any type of device that performs aspiration and/or dispensation of liquid to support analysis of a sample including high-pressure liquid chromatography systems, solid phase extraction systems, etc. In the illustrative embodiment, liquid handling system 100 may include a work bed 102, a rack 104, a controller housing 106, and an arm 108 to which a probe (not shown) may be mounted.

Work bed 102 may include a bed plate 110 and one or more side walls 112 that generally extend up from bed plate 110 away from a base 114 of liquid handling system 100. Work bed 102 may have a variety of shapes (circular, elliptical, polygonal, etc.) and sizes based on the processing performed by liquid handling system 100. Work bed 102 further may be formed of a variety of materials based on the processing performed by liquid handling system 100. For example, a metal or plastic may be used to form work bed 102. Work bed 102 is fixedly or removably mounted on base 114. As used in this disclosure, the term “mount” includes support, join, unite, connect, associate, insert, hang, hold, affix, attach, fasten, bind, paste, secure, bolt, screw, rivet, solder, weld, glue, form over, layer, and other like terms. The phrases “mounted on” and “mounted to” include any interior or exterior portion of the element referenced. As used herein, the mounting may be a direct mounting between the referenced components or an indirect mounting through intermediate components between the referenced components.

Rack 104 is fixedly or removably mounted on work bed 102. Work bed 102 may be sized and shaped to support one or more racks of the same or different type in various locations. Rack 104 is configured to hold one or more receptacles. The one or more receptacles are configured to hold a sample for analysis and/or a liquid for analysis of the sample and/or a liquid for preparation of the sample for analysis. For illustration, the one or more receptacles may be vials, test tubes, bottles, etc. of various shapes and sizes. The sample may be in liquid or solid form. Rack 104 may have a variety of shapes (circular, elliptical, polygonal, etc.) and sizes based on the processing performed by liquid handling system 100. Rack 104 further may be formed of a variety of materials based on the processing performed by liquid handling system 100. For example, a metal or plastic may be used to form rack 104. Rack 104 further may include pumps, diluters, valves, heaters, chillers, analysis components, microplates, etc. to support the analysis of the sample or the preparation of the sample for analysis.

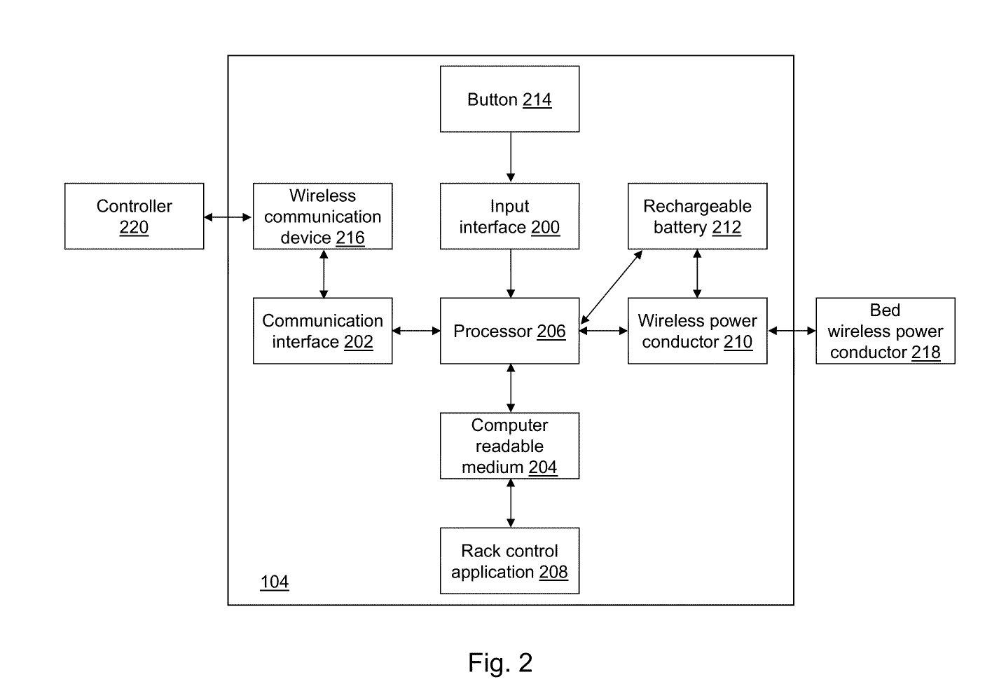

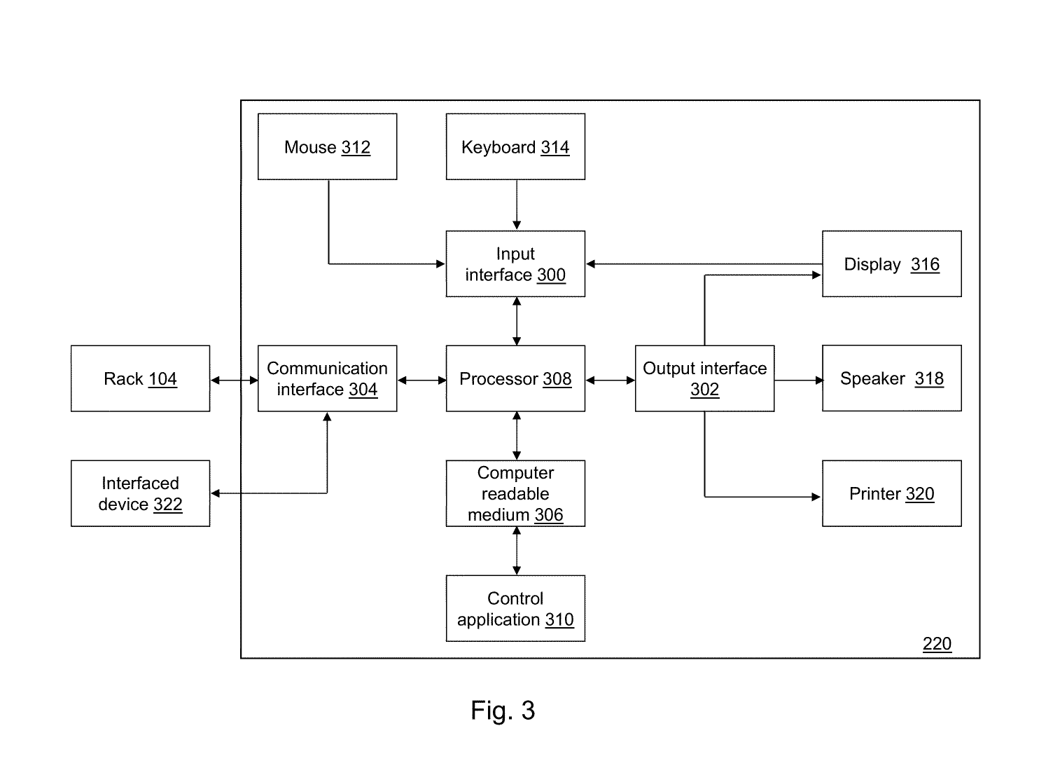

Controller housing 106 houses a controller 220 (shown with reference to FIGS. 2 and 3) of liquid handling system 100. The controller controls the operation of the components of liquid handling system 100. For example, controller 220 may be operably coupled to a drive system 116. Drive system 116 includes one or more actuators operably coupled to control movement of one or more arms arranged to position the probe over a receptacle mounted to rack 104. For example, drive system 116 controls movement of arm 108. Illustrative actuators, as used herein, include an electric motor, a servo, stepper, or piezo motor, a pneumatic actuator, a gas motor, etc. Drive system 116 may provide movement in one-, two-, or three-dimensions. In the illustrative embodiment of FIG. 1, drive system 116 provides movement of the probe in three-dimensions relative to bed plate 110. Controller 220 may also control liquid pumping including aspiration and dispensing of sample and other liquids for analysis or preparation of the sample for analysis.

With reference to FIG. 2, rack 104 of liquid handling system 100 is shown in accordance with an illustrative embodiment. In an illustrative embodiment, rack 104 further may include an input interface 200, a communication interface 202, a computer-readable medium 204, a processor 206, a rack control application 208, a wireless power conductor 210, and a rechargeable battery 212. Different, fewer, and additional components may be incorporated into rack 104.

Input interface 200 provides an interface for receiving information from the user for entry into rack 104 as known to those skilled in the art. Input interface 200 may interface with various input technologies including, but not limited to, a button 214, a keyboard, a touch screen, a mouse, a track ball, a keypad, etc. to allow the user to enter information into rack 104 or to make selections presented in a user interface displayed on the touch screen. Rack 104 may have one or more input interfaces that use the same or a different input interface technology.

Communication interface 202 provides an interface for receiving and transmitting data between devices using various protocols, transmission technologies, and media as known to those skilled in the art. Communication interface 202 may support communication using various transmission media that may be wired or wireless. In an illustrative embodiment, communication interface 202 supports communication to a wireless communication device 216 to avoid the cabling and wiring associated with wired communication devices. Illustrative wireless communication devices include antennas that receive and transmit electromagnetic radiation at various frequencies. Rack 104 may have one or more communication interfaces that use the same or a different communication interface technology. Data and messages may be transferred between rack 104 and controller 220 using wireless communication device 216.

Computer-readable medium 204 is an electronic holding place or storage for information so that the information can be accessed by processor 206 as known to those skilled in the art. Computer-readable medium 204 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. Rack 104 may have one or more computer-readable media that use the same or a different memory media technology. Rack 104 also may have one or more drives that support the loading of a memory media such as a CD or DVD.

Processor 206 executes instructions as known to those skilled in the art. The instructions may be carried out by a special purpose computer, logic circuits, or hardware circuits. Thus, processor 206 may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor 206 executes an instruction, meaning that it performs/controls the operations called for by that instruction. Processor 206 operably couples with input interface 200, with computer-readable medium 204, with communication interface 202, and with wireless power conductor 210 to receive, to send, and to process information. Processor 206 may retrieve a set of instructions from a permanent memory device and copy the instructions in an executable form to a temporary memory device that is generally some form of RAM. Rack 104 may include a plurality of processors that use the same or a different processing technology.

Rack control application 208 performs operations associated with controlling, maintaining, updating, etc. the operation of rack 104. Some or all of the operations described herein may be controlled by instructions embodied in rack control application 208. The operations may be implemented using hardware, firmware, software, or any combination of these methods. With reference to the example embodiment of FIG. 2, rack control application 208 is implemented in software (comprised of computer-readable and/or computer-executable instructions) stored in computer-readable medium 204 and accessible by processor 206 for execution of the instructions that embody the operations of rack control application 208. Rack control application 208 may be written using one or more programming languages, assembly languages, scripting languages, etc.

Rack control application 208 may be configured to identify characteristics of rack 104 such as a model number, a number of the receptacles, an indicator of a geometrical arrangement of the receptacles, etc. Rack control application 208 further may be configured to receive information identifying a content of the one or more receptacles, an indicator of one or more processing steps performed on the one or more receptacles, an indicator of one or more processing steps to be performed on the one or more receptacles, an indicator of where rack 104 should be positioned on work bed 102, an indicator of one or more devices that have interacted with rack 104, etc. Rack control application 208 further may be configured to send information to controller 220.

Wireless power conductor 210 receives energy by electromagnetic induction from a bed wireless power conductor 218. For example, bed wireless power conductor 218 may be mounted to bed plate 110 and/or to one or more of the one or more side walls 112 of work bed 102. Wireless power is the transmission of electrical energy from a power source to an electrical load without a conductive physical connection. Wireless power transmission avoids the use of interconnecting wires, which makes rack 104 easier to clean and more portable. Wireless power transmission may be carried out using direct induction based on a magnetic or a capacitive coupling between the wireless power conductors. As a result, wireless power conductor 210 receives energy when it is positioned proximate bed wireless power conductor 218, but not in contact with bed wireless power conductor 218. Rack 104 may include a plurality of wireless power conductors that have the same or different shapes and are formed of the same or different types of materials.

Rechargeable battery 212 is coupled to receive charging power from wireless power conductor 210. Rechargeable battery 212 may be formed of a variety of chemicals as understood by a person of skill in the art. Rechargeable battery 212 is selected to provide sufficient power to operate rack 104 when wireless power conductor 210 is not positioned to receive power from wireless power conductor 218. Rack control application 208 may control the charging/discharging of rechargeable battery 212.

With reference to FIG. 3, controller 220 of liquid handling system 100 is shown in accordance with an illustrative embodiment. In an illustrative embodiment, controller 220 may include a second input interface 300, an output interface 302, a second communication interface 304, a second computer-readable medium 306, a second processor 308, and a control application 310. Different, fewer, and additional components may be incorporated into controller 220.

Second input interface 300 provides the same or similar functionality as that described with reference to input interface 200 of rack 104. As examples, second input interface 300 may interface with various input technologies including, but not limited to, one or more buttons, a mouse 312, a keyboard 314, a display 316, a track ball, a keypad, etc. to allow the user to enter information into controller 220 or to make selections presented in a user interface displayed on display 316.

Output interface 302 provides an interface for outputting information for review by a user of controller 220. For example, output interface 302 may interface with various output technologies including, but not limited to, display 316, a speaker 318, a printer 320, etc. Display 316 may be a thin film transistor display, a light emitting diode display, a liquid crystal display, or any of a variety of different displays known to those skilled in the art. Speaker 318 may be any of a variety of speakers as known to those skilled in the art. Printer 320 may be any of a variety of printers as known to those skilled in the art. Controller 220 may have one or more output interfaces that use the same or a different interface technology. As an alternative, one or more of the various input and output technologies may interface with controller 220 through second communication interface 304.

Second communication interface 304 provides the same or similar functionality as that described with reference to communication interface 202 of rack 104. Controller 220 may be linked to one or more interfaced devices 322. For example, controller 220 may interface with another liquid handler or an external computing device. If connected, controller 220 and the one or more interfaced devices 322 may be connected directly or through a network. The network may be any type of wired and/or wireless public or private network including a cellular network, a local area network, a wide area network such as the Internet, etc. Controller 220 may send and receive information to/from one or more of the interfaced devices 322. For example, controller 220 may send results obtained for a sample for storage on one or more of the interfaced devices 322. As another example, controller 220 may receive software updates from one or more of the interfaced devices 322 and/or receive commands from one or more of the interfaced devices 322. The commands may control operation of one or more components of liquid handling system 100 including controller 220 and rack 104. The one or more interfaced devices 322 may include a computing device of any form factor such as a personal digital assistant, a desktop computer, a laptop computer, an integrated messaging device, a cellular telephone, a smart phone, a pager, etc. without limitation.

Second computer-readable medium 306 provides the same or similar functionality as that described with reference to computer-readable medium 204 of rack 104. Second processor 308 provides the same or similar functionality as that described with reference to processor 206 of rack 104.

Control application 310 performs operations associated with controlling, maintaining, updating, etc. the operation of liquid handling system 100. Some or all of the operations described herein may be controlled by instructions embodied in control application 310. The operations may be implemented using hardware, firmware, software, or any combination of these methods. With reference to the example embodiment of FIG. 3, control application 310 is implemented in software (comprised of computer-readable and/or computer-executable instructions) stored in second computer-readable medium 306 and accessible by second processor 308 for execution of the instructions that embody the operations of control application 310. Control application 310 may be written using one or more programming languages, assembly languages, scripting languages, etc.

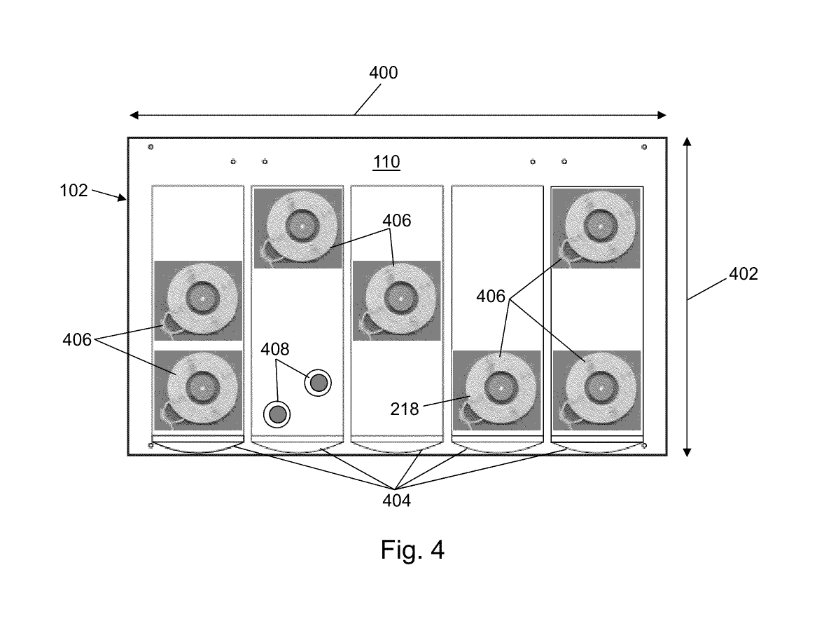

With reference to FIG. 4, a top view of work bed 102 of liquid handling system 100 is shown in accordance with an illustrative embodiment. In the illustrative embodiment, work bed 102 has a width 400 and a length 402. Rack outlines 404 indicate a layout for typical sized and shaped racks though other sized and shaped racks may be mounted on bed plate 110. The arrangement and position of a plurality of bed wireless power conductors 406 is selected based on various embodiments of rack 104 and the mounting location of wireless power conductor 210 on rack 104. The plurality of bed wireless power conductors 406 are shown mounted on bed plate 110 though other bed wireless power conductors may be mounted to the one or more side walls 112 of work bed 102. The plurality of bed wireless power conductors 406 include bed wireless power conductor 218 for illustration. Work bed 102 may include a fewer or a greater number of bed wireless power conductors. The plurality of bed wireless power conductors 406 further may be positioned at alternative locations selected based on a size and shape of various embodiments of rack 104. The plurality of bed wireless power conductors 406 are positioned so that at least one of the plurality of bed wireless power conductors 406 is sufficiently aligned with rack 104 to transfer energy by electromagnetic induction to wireless power conductor 210 of rack 104 when rack 104 is positioned on work bed 102 for operation by liquid handling system 100.

One or more valves 408 may further be mounted in be plate 110 and/or the one or more side walls 112 of work bed 102. The valves may align with valves formed in rack 104 to extract material (liquid, gas, solid) from rack 104, for example, as part of a sample processing step.

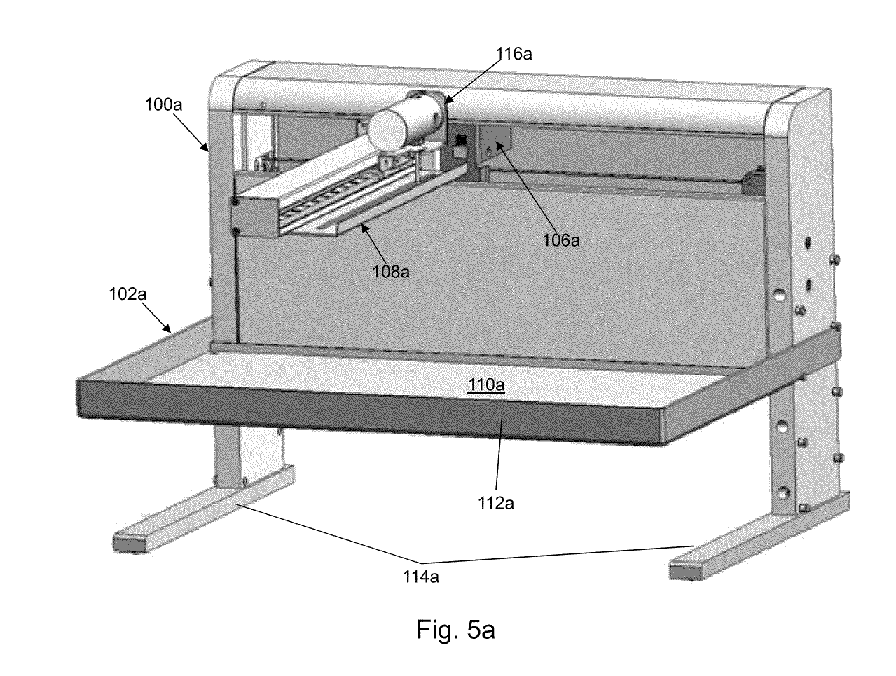

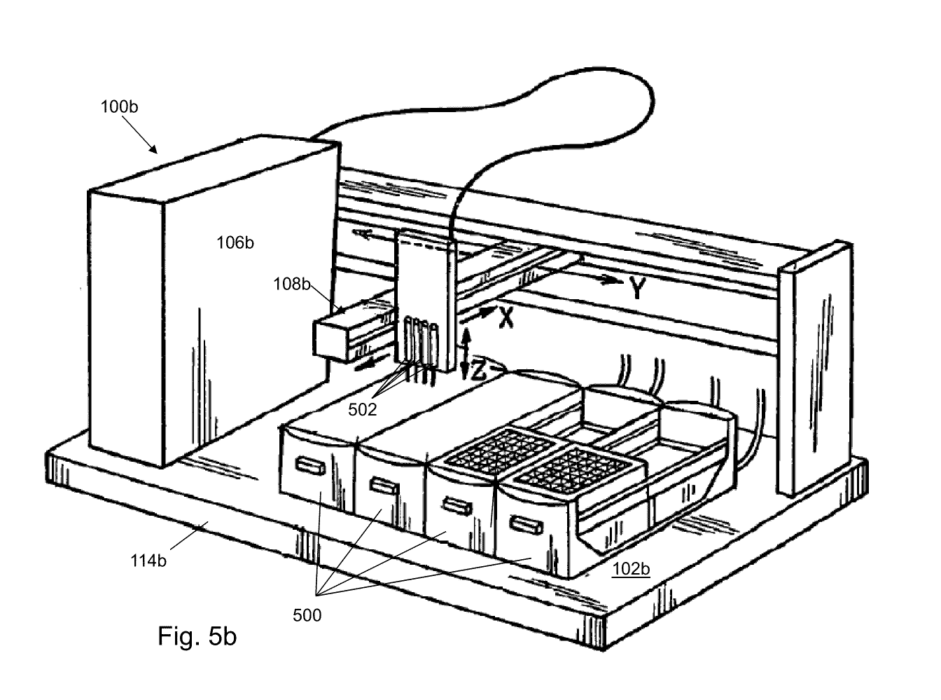

With reference to FIG. 5a, a schematic diagram of a second liquid handling system 100a is shown in accordance with an illustrative embodiment. In the illustrative embodiment, second liquid handling system 100a may include a second work bed 102a, a second controller housing 106a, and a second arm 108a to which a probe (not shown) may be mounted. Second work bed 102a may include a second bed plate 110a and second side walls 112a that generally extend up from second bed plate 110a away from a second base 114a of second liquid handling system 100a. One or more of the plurality of bed wireless power conductors 406 may be mounted to second work bed 102a. Additionally, one or more racks may be mounted to second work bed 102a in alignment with at least one of the plurality of bed wireless power conductors 406. In the illustrative embodiment of FIG. 5a, a second drive system 116a controls movement of second arm 108a in two-dimensions.

With reference to FIG. 5b, a schematic diagram of a third liquid handling system 100b is shown in accordance with an illustrative embodiment. In the illustrative embodiment, third liquid handling system 100b may include a third work bed 102b, a plurality of racks 500, a third controller housing 106b, and a third arm 108b to which a plurality of probes 502 are mounted. The plurality of racks 500 are fixedly or removably mounted on third work bed 102b. Though in the illustrative embodiment of FIG. 5b, the plurality of racks 500 are all the same, the plurality of racks 500 may include different types and sizes of racks. Third work bed 102b is integrated with a third base 114b. One or more of the plurality of bed wireless power conductors 406 may be mounted to third work bed 102b. Additionally, the plurality of racks 500 may be mounted to third work bed 102b in alignment with at least one of the plurality of bed wireless power conductors 406.

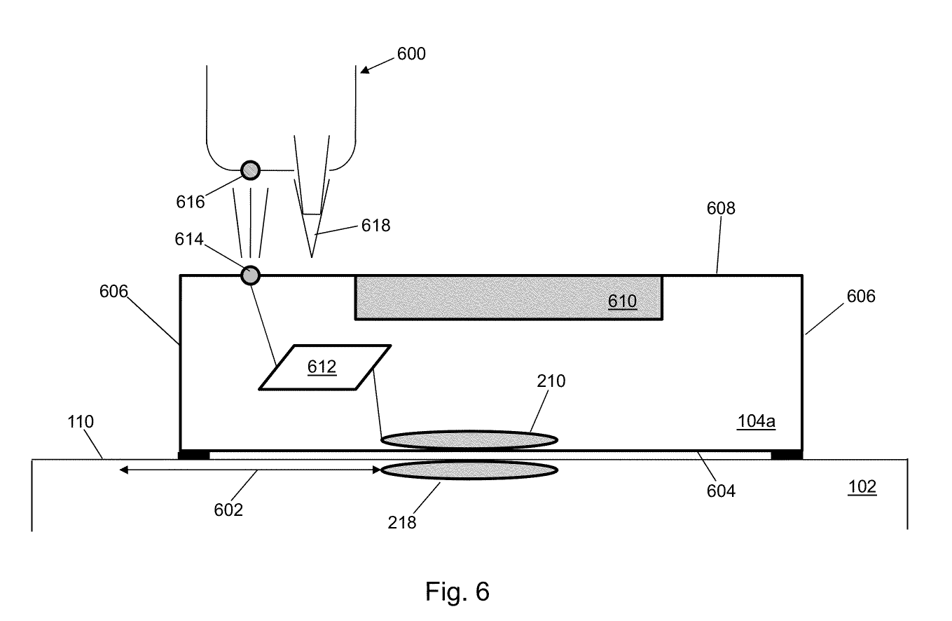

With reference to FIG. 6, a schematic diagram of work bed 102, a second rack 104a, and a probe device 600 are shown in accordance with an illustrative embodiment. In the illustrative embodiment, work bed 102 includes bed plate 110 to which bed wireless power conductor 218 is mounted. Bed wireless power conductor 218 may be connected via a wire 602 to an external circuit that provides a power signal to bed wireless power conductor 218.

In the illustrative embodiment of FIG. 6, second rack 104a includes a base 604, a plurality of walls 606 extending from base 604, and a plate 608. Plate 608 extends between the plurality of walls 606 opposite base 604. In the illustrative embodiment, plate 608 includes a cavity configured to hold a receptacle. The receptacle is configured to hold a liquid for analysis of a sample.

As illustrated, wireless power conductor 210 is mounted to base 604 at a position such that wireless power conductor 210 generally aligns with bed wireless power conductor 218 so that wireless power conductor 210 receives energy by electromagnetic induction from bed wireless power conductor 218. Second rack 104a may further include an electronic circuit 612 and a light element 614. Electronic circuit 612 is coupled to wireless power conductor 210 to receive power from wireless power conductor 210. In an illustrative embodiment, electronic circuit 612 may include one or more of input interface 200, communication interface 202, computer-readable medium 204, processor 206, rack control application 208, and rechargeable battery 212. Light element 614 is coupled to electronic circuit 612 to receive power to control operation of light element 614. In an illustrative embodiment, light element 614 is a light emitting diode though other light elements may be used.

Though not shown, probe device 600 may be mounted to arm 108, 108a, 108b. Probe device 600 may include a second light element 616 and a probe 618. Second light element 616 is mounted to an end of probe device 600 adjacent to probe 618. In an illustrative embodiment, light element 614 is a photodiode though other light elements may be used. Probe 618 is configured to aspirate or dispense liquid into the receptacle. Second light element 616 and light element 614 are used to align probe 618 with the receptacle. Thus, a measurement of light emitted by light element 614 and detected by second light element 616 may be used by controller 220 to move probe 618 into a proper alignment with second rack 104a. Alternatively, a measurement of light emitted by second light element 616 and detected by light element 614 may be received by processor 206 and sent to controller 220 using communication interface 202. Controller 220 may send commands to the actuators to move the components of drive system 116, 116a thereby moving probe 618 into the proper alignment with second rack 104a.

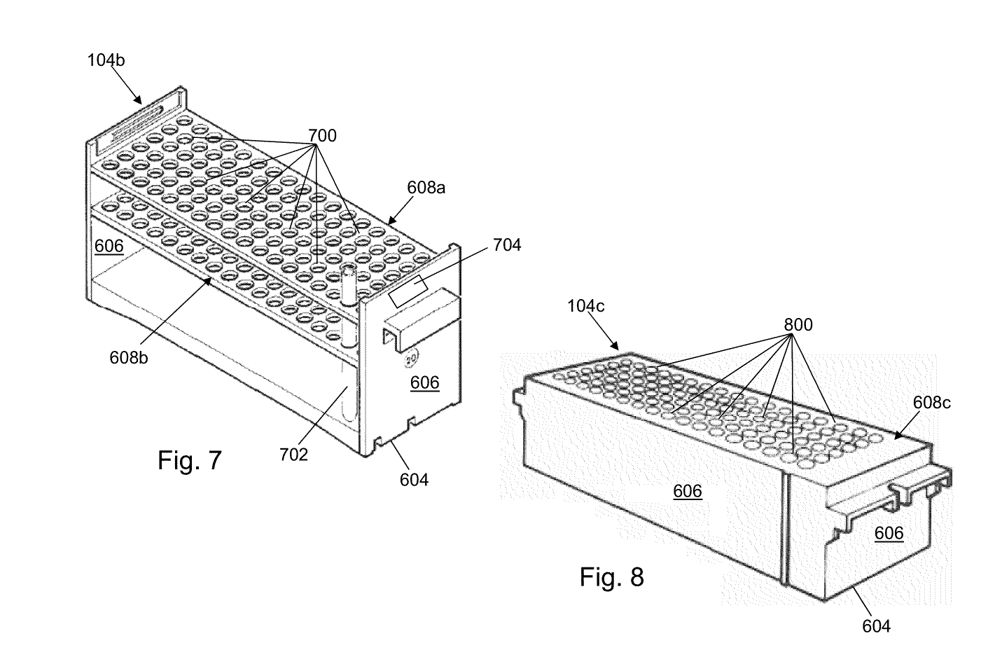

In the illustrative embodiment of FIG. 7, a third rack 104b is shown in accordance with an illustrative embodiment. Third rack 104b may include base 604, the plurality of walls 606 extending from base 604, a second plate 608a, and a third plate 608b. Second plate 608a extends between the plurality of walls 606 opposite base 604. Third plate 608b extends between the plurality of walls 606 between base 604 and second plate 608a. In the illustrative embodiment, second plate 608a and third plate 608b include a plurality of aligned cavities 700. Each cavity of the plurality of aligned cavities 700 is configured to hold a receptacle 702. Receptacle 702 is configured to hold a liquid for analysis of a sample. In the illustrative embodiment, receptacle 702 is a vial. Receptacle 702 may have a variety of shapes and sizes and may be formed of a variety of materials including glass, plastic, metal, etc.

Though not shown, third rack 104b includes wireless power conductor 210, electronic circuit 612, and a transmitter 704 coupled to electronic circuit 612 to receive power to control operation of transmitter 704. For example, transmitter 704 may include a radio frequency identifier tag that identifies characteristics of third rack 104b such as the model number, number of cavities of the plurality of aligned cavities 700, an indicator of a geometrical arrangement of the plurality of aligned cavities 700, etc.

In the illustrative embodiment of FIG. 8, a fourth rack 104c is shown in accordance with an illustrative embodiment. Fourth rack 104c may include base 604, the plurality of walls 606 extending from base 604, and a fourth plate 608c. Fourth plate 608c extends between the plurality of walls 606 opposite base 604. Instead of two walls 606, as shown with reference to third rack 104b, fourth rack 104c includes four side walls to form a housing. In the illustrative embodiment, fourth plate 608c includes a plurality of cavities 800 that extend into the housing of fourth rack 104c formed by the plurality of walls 606 and base 604. Each cavity of the plurality of cavities 800 is configured to hold a liquid for analysis of the sample.

Though not shown, fourth rack 104c includes wireless power conductor 210 and electronic circuit 612. In an illustrative embodiment, fourth rack 104c includes a chiller element mounted and configured to cool the receptacles inserted into the plurality of cavities 800. In an illustrative embodiment, the chiller element may comprise a Peltier module manufactured by CUI, Inc. The chiller element may be coupled or mounted to wireless power conductor 210 and/or electronic circuit 612. As an example, controller 220 may send a communication to fourth rack 104c through communication interface 202 that indicates the temperature at which to maintain the receptacles. The temperature may be stored in computer readable medium 204 and processor 206, executing rack control application 208, may send temperature control commands to the chiller element to control operation of the chiller element. Fourth rack 104c may further include a sensor such as a thermometer to measure the temperature of the receptacles and to report the temperature to controller 220.

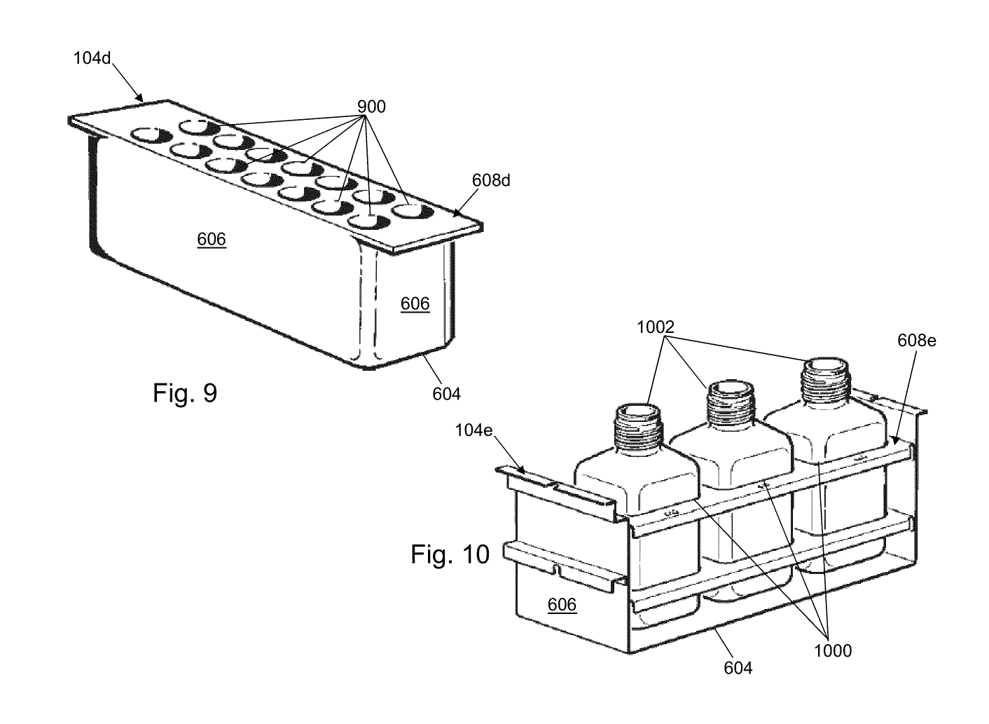

In the illustrative embodiment of FIG. 9, a fifth rack 104d is shown in accordance with an illustrative embodiment. Fifth rack 104d may include base 604, the plurality of walls 606 extending from base 604, and a fifth plate 608d. Fifth plate 608d extends between the plurality of walls 606 opposite base 604. Instead of two walls 606, as shown with reference to third rack 104b, fifth rack 104d includes four side walls to form a housing. In the illustrative embodiment, fifth plate 608d includes a second plurality of cavities 900 that extend into the housing of fifth rack 104d formed by the plurality of walls 606 and base 604. Each cavity of the second plurality of cavities 900 is configured to hold a receptacle.

Though not shown, fifth rack 104d includes wireless power conductor 210 and electronic circuit 612. In an illustrative embodiment, fifth rack 104d includes a heater element mounted and configured to heat the receptacles inserted into the second plurality of cavities 900. The heater element may be coupled or mounted to wireless power conductor 210 and/or electronic circuit 612. As an example, controller 220 may send a communication to fifth rack 104d through communication interface 202 that indicates the temperature at which to maintain the receptacles. The temperature may be stored in computer readable medium 204 and processor 206, executing rack control application 208, may send temperature control commands to the heater element to control operation of the heater element. Fifth rack 104d may further include a sensor such as a thermometer to measure the temperature of the receptacles and to report the temperature to controller 220. Fifth rack 104d may further include a scale to measure a weight of the receptacles and to report the weight to controller 220. For example, controller 220 may determine an amount of evaporation from the receptacles based on the weight.

In the illustrative embodiment of FIG. 10, a sixth rack 104e is shown in accordance with an illustrative embodiment. Sixth rack 104e may include base 604, the plurality of walls 606 extending from base 604, and a sixth plate 608e. Sixth plate 608e extends between the plurality of walls 606 opposite base 604. In the illustrative embodiment, sixth plate 608e includes a third plurality of cavities 1000 where each cavity of the third plurality of cavities 1000 is configured to hold a receptacle of a plurality of receptacles 1002. In the illustrative embodiment, the plurality of receptacles 1002 are bottles.

Though not shown, sixth rack 104e includes wireless power conductor 210 and electronic circuit 612. In an illustrative embodiment, sixth rack 104e includes a balance mounted and configured to identify a differential weight associated with the plurality of receptacles 1002 inserted into the third plurality of cavities 1000. The balance may be coupled or mounted to wireless power conductor 210 and/or electronic circuit 612. As an example, sixth rack 104e may send a communication to controller 220 through communication interface 202 that indicates a differential between the weights of the plurality of receptacles 1002. Sixth rack 104e may further include a scale to measure a weight of the plurality of receptacles 1002 and to report the weight to controller 220. For example, controller 220 may determine when the plurality of receptacles 1002 need to be refilled (due to liquid extraction and/or evaporation) based on the weight and may determine a liquid level in the plurality of receptacles 1002 based on the weight as a function of time.

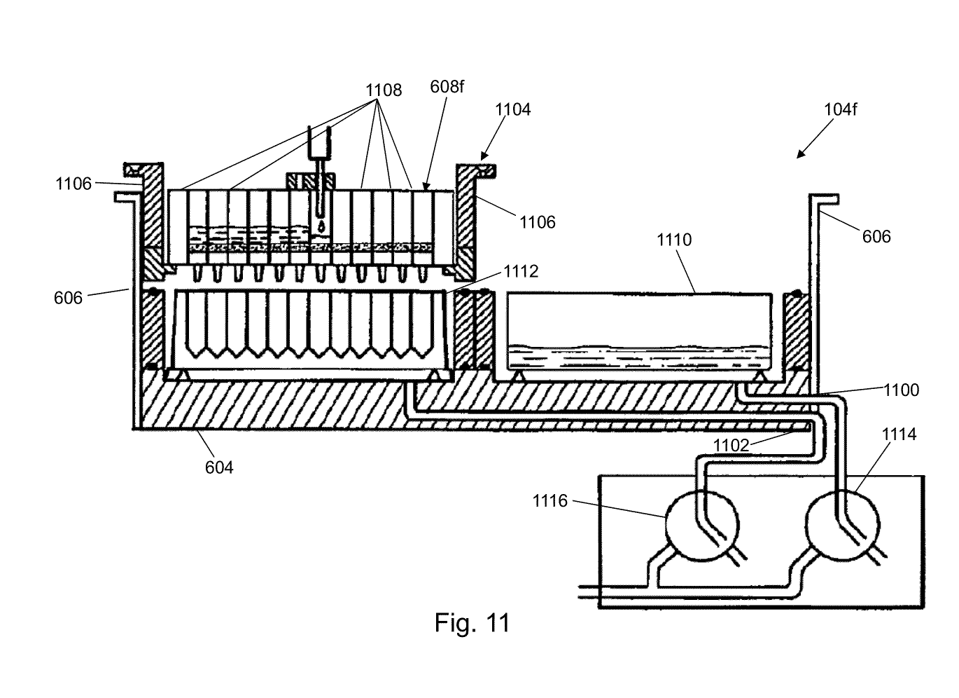

In the illustrative embodiment of FIG. 11, a seventh rack 104f is shown in accordance with an illustrative embodiment. Seventh rack 104f may include base 604, the plurality of walls 606 extending from base 604, a first port 1100, and a second port 1102. Seventh rack 104f further may include a first sub-rack 1104 that is configured to be moved between the plurality of walls 606 of seventh rack 104f. First sub-rack 1104 may include a seventh plate 608f that extends between a second plurality of walls 1106 of first sub-rack 1104. In the illustrative embodiment, seventh plate 608f includes a fourth plurality of cavities 1108 where each cavity of the fourth plurality of cavities 1108 is configured to hold a receptacle of a plurality of receptacles.

Seventh rack 104f further may include a drain receptacle 1110 and a column receptacle 1112. First port 1100 connects between drain receptacle 1110 and a first valve 1114, and second port 1102 connects between column receptacle 1112 and a second valve 1116. First valve 1114 and second valve 1116 may be used to switch in and out a vacuum source to withdraw fluid from drain receptacle 1110 and column receptacle 1112, respectively. Though not shown as such, first valve 1114 and second valve 1116 are mounted within seventh rack 104f. Seventh rack 104f may be configured to perform a solid phase extraction process on samples contained within the fourth plurality of cavities 1108 as understood by a person of skill in the art.

Though not shown, seventh rack 104f includes wireless power conductor 210 and electronic circuit 612. First valve 1114 and second valve 1116 may be coupled or mounted to wireless power conductor 210 and/or electronic circuit 612. As an example, seventh rack 104f may receive a communication from controller 220 through communication interface 202 that indicates one or the other of first valve 1114 and second valve 1116 should be opened or closed. First valve 1114 and second valve 1116 may be aligned with the one or more valves 408 of work bed 102.

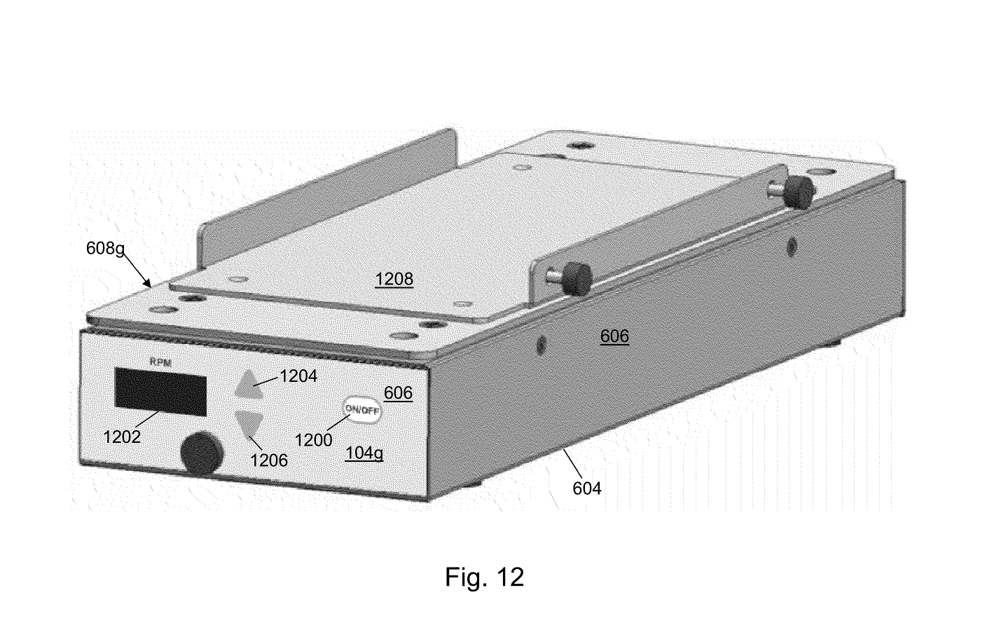

In the illustrative embodiment of FIG. 12, an eighth rack 104g is shown in accordance with an illustrative embodiment. Eighth rack 104g may include base 604, the plurality of walls 606 extending from base 604, and an eighth plate 608g. Though not shown, eighth rack 104g includes wireless power conductor 210 mounted to base 604 (or the plurality of walls 606) and electronic circuit 612. In an illustrative embodiment, eighth rack 104g includes an actuator (not shown) operably coupled to move a shaker plate 1208. Eighth rack 104g further may include an on/off button 1200, a display 1202, an up button 1204, and a down button 1206. On/off button 1200, up button 1204, and down button 1206 are examples of button 214 and allow a user to control the speed of movement of shaker plate 1208. Display 1202 presents a current speed setting to the user. On/off button 1200, display 1202, up button 1204, and down button 1206 may be coupled to electronic circuit 612.

In an illustrative embodiment, rack 104, second rack 104a, third rack 104b, fourth rack 104c, fifth rack 104d, sixth rack 104e, and/or seventh rack 104f may be mounted on shaker plate 1208. Movement of shaker plate 1208 results in mixing of the contents of the receptacles included in rack 104, second rack 104a, third rack 104b, fourth rack 104c, fifth rack 104d, sixth rack 104e, and/or seventh rack 104f. The actuator may be coupled to wireless power conductor 210 and/or electronic circuit 612 to receive power to control operation of the actuator. As an example, eighth rack 104g may receive a communication from controller 220 through communication interface 202 to move shaker plate 1208 for a specified period of time.

Eighth rack 104g further may include a second wireless power conductor mounted to eighth plate 608g. The second wireless power conductor of eighth rack 104g may be aligned with wireless power conductor 210 of rack 104, second rack 104a, third rack 104b, fourth rack 104c, fifth rack 104d, sixth rack 104e, and/or seventh rack 104f to transfer energy by electromagnetic induction to wireless power conductor wireless power conductor 210 of rack 104, second rack 104a, third rack 104b, fourth rack 104c, fifth rack 104d, sixth rack 104e, and/or seventh rack 104f.

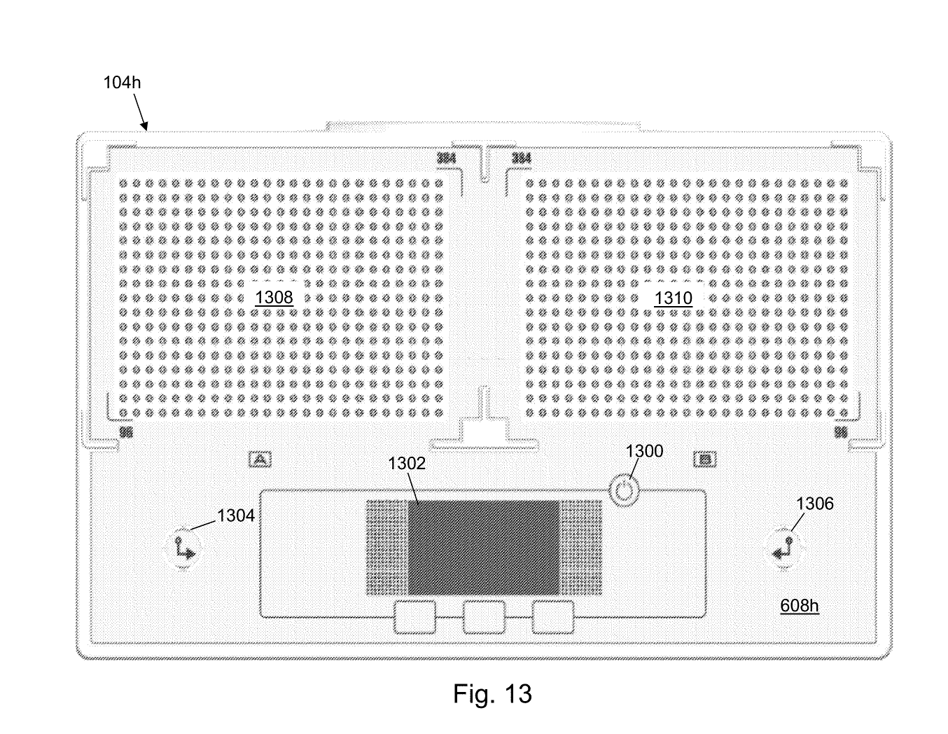

In the illustrative embodiment of FIG. 13, a ninth rack 104h is shown in accordance with an illustrative embodiment. Though not shown, ninth rack 104h may include base 604 and the plurality of walls 606 extending from base 604. Ninth rack 104h includes a ninth plate 608h. Though not shown, ninth rack 104h includes wireless power conductor 210 mounted to base 604 (or the plurality of walls 606) and electronic circuit 612. In an illustrative embodiment, ninth rack 104h includes a plurality of light elements arranged to form a first grid 1308 and a second grid 1310. Ninth rack 104h further may include an on/off button 1300, a display 1302, a right button 1304, and a left button 1306. Display 1202, right button 1304, and left button 1306 present indicators of a current pipetting sequence relative to ninth plate 608h. On/off button 1300, display 1302, right button 1304, and left button 1306 may be coupled to electronic circuit 612.

In an illustrative embodiment, rack 104, second rack 104a, third rack 104b, fourth rack 104c, fifth rack 104d, sixth rack 104e, and/or seventh rack 104f may be mounted on ninth plate 608h over first grid 1308 or second grid 1310. Light elements in first grid 1308 and in second grid 1310 are used to indicate a next receptacle in which pipetting is to be performed by liquid handling system 100. The light elements may be coupled to wireless power conductor 210 and/or electronic circuit 612 to receive power to control operation of the light elements.

Ninth rack 104h further may include a second wireless power conductor mounted to ninth plate 608h. The second wireless power conductor of ninth rack 104h may be aligned with wireless power conductor 210 of rack 104, second rack 104a, third rack 104b, fourth rack 104c, fifth rack 104d, sixth rack 104e, and/or seventh rack 104f to transfer energy by electromagnetic induction to wireless power conductor wireless power conductor 210 of rack 104, second rack 104a, third rack 104b, fourth rack 104c, fifth rack 104d, sixth rack 104e, and/or seventh rack 104f.

The aspects described with reference to rack 104, second rack 104a, third rack 104b, fourth rack 104c, fifth rack 104d, sixth rack 104e, seventh rack 104f, eighth rack 104g, and/or ninth rack 104h may be combined in various combinations into a single rack.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A rack used in a device for preparing or analyzing a sample, the rack comprising:
a base;
a plurality of walls extending from the base;
a plate extending between the plurality of walls opposite the base, the plate comprising a plurality of cavities, wherein each cavity of the plurality of cavities is configured to hold a receptacle that is configured to hold a liquid for analysis of a sample or each cavity of the plurality of cavities is configured to hold the liquid for analysis of the sample; and
a wireless power conductor mounted to the base and configured to receive energy by electromagnetic induction from a second wireless power conductor.

2. The rack of claim 1, wherein the electromagnetic induction is based on a magnetic or a capacitive coupling between the wireless power conductor and the second wireless power conductor.

3. The rack of claim 1, further comprising:
a second base;
a second plurality of walls extending from the second base;
a second plate extending between the second plurality of walls opposite the second base, wherein the base is mounted to the second plate;
the second wireless power conductor mounted to the second plate and configured to transfer energy by electromagnetic induction to the wireless power conductor; and
a third wireless power conductor mounted to the second base and configured to receive energy by electromagnetic induction from a fourth wireless power conductor.

4. The rack of claim 3, further comprising an electronic circuit coupled to the third wireless power conductor to receive power.

5. The rack of claim 4, further comprising an actuator operably coupled to move the second plate, the actuator coupled to the electronic circuit to receive power to control operation of the actuator.

6. The rack of claim 4, wherein the second plate comprises a light element positioned below the receptacle, the light element coupled to the electronic circuit to receive power to control operation of the light element.

7. The rack of claim 1, further comprising an electronic circuit coupled to the wireless power conductor to receive power.

8. The rack of claim 7, further comprising a rechargeable battery coupled to the wireless power conductor to receive power.

9. The rack of claim 8, wherein the electronic circuit is coupled to the rechargeable battery to receive power when the wireless power conductor is not receiving energy by electromagnetic induction from the second wireless power conductor.

10. The rack of claim 7, further comprising a heater element mounted to the plate to transfer heat to the receptacle, the heater element coupled to the electronic circuit to receive power to control operation of the heater element.

11. The rack of claim 7, further comprising a chiller element mounted to the plate to cool the receptacle, the chiller element coupled to the electronic circuit to receive power to control operation of the chiller element.

12. The rack of claim 7, further comprising a valve configured to open for fluid transfer of a fluid out of the rack, the valve coupled to the electronic circuit to receive power to control operation of the valve.

13. The rack of claim 7, further comprising a sensor mounted to the rack, the sensor coupled to the electronic circuit to receive power to control operation of the sensor.

14. The rack of claim 7, further comprising a transmitter coupled to the electronic circuit to receive power to control operation of the transmitter.

15. The rack of claim 7, wherein the plate comprises a light element coupled to the electronic circuit to receive power to control operation of the light element.

16. The rack of claim 7, further comprising a wireless communication device, wherein the electronic circuit comprises:
a processor;
a communication interface operably coupled to the processor; and
a computer-readable medium having computer-readable instructions stored thereon that, when executed by the processor, control the wireless communication device to transmit information about the plate to a second device.

17. The rack of claim 7, further comprising a wireless communication device, wherein the electronic circuit comprises:
a processor;
a communication interface operably coupled to the processor; and
a computer-readable medium having computer-readable instructions stored thereon that, when executed by the processor, control the wireless communication device to transmit information about the sample to a second device.

18. The rack of claim 7, further comprising a wireless communication device, wherein the electronic circuit comprises:
a processor;
a communication interface operably coupled to the processor; and
a computer-readable medium having computer-readable instructions stored thereon that, when executed by the processor, control the wireless communication device to receive information about an instrument analyzing the sample from a second device.

19. The rack of claim 18, wherein the instrument and the second device are the same device.

20. A liquid handling system comprising:
a work bed comprising a bed plate;
a first wireless power conductor mounted to the work bed and configured to transmit energy through electromagnetic induction;
a drive system;
an arm mounted to the drive system;
a probe mounted to the arm;
a rack configured for mounting on the bed plate, the rack comprising
a base;
a plurality of walls extending from the base;
a rack plate extending between the plurality of walls opposite the base, the rack plate comprising a plurality of cavities, wherein each cavity of the plurality of cavities is configured to hold a receptacle that is configured to hold a liquid for analysis of a sample or is configured to hold the liquid for analysis of the sample; and
a second wireless power conductor mounted to the base and configured to receive energy by electromagnetic induction from the first wireless power conductor when the second wireless power conductor is positioned proximate, but not in contact with the first wireless power conductor; and
an actuator operably coupled to control movement of the drive system to position the probe over the receptacle.
